(19) United States
(12) Patent Application Publication
(10) Pub. No.: US 2006/0203430 A1
(43) Pub. Date: Sep. 14, 2006

(54) Method and device for driving solid electrolyte cells

(75) Inventors: Cay-Uwe Pinnow, Munchen (DE); Ralf Symanczyk, Tuntenhausen (DE)

Correspondence Address: Maginot, Moore & Beck;Chase Tower, Suite 3250, 111 Monument Circle, Indianapolis, IN, 46204, US

(73) Assignee: Infineon Technologies AG, Munchen (DE)

(21) Appl. No.: 11/343,923

(22) Filed: Jan. 31, 2006

(30) Foreign Application Priority Data
Jan. 31, 2005 (DE) 10 2005 004 434.4

(51) Int. Cl. H01G 9/04

(52) U.S. Cl. 361/528

(57) ABSTRACT

An electrical switching device comprises a switching element and a heating device for heating the switching element. The switching element comprises a first electrode, a second electrode, and an electrolyte layer arranged between and contact-connected to the first and second electrode. The switching element is configured to establish a conducting path between the first and second electrodes via the electrolyte layer by conduction elements having diffused from the first electrode into the electrolyte layer.

### BACKGROUND OF THE INVENTION

1. Field of the Invention

The present invention relates generally to solid-electrolyte-based memory cells, and relates in particular to switching operations such as, for instance, an erasure and/or a setting (programming) of solid electrolyte cells, and to a switching device for carrying out the method. In particular, the present invention relates to a switching method for accelerating switching operations within a solid electrolyte of a memory cell.

2. Description of the Related Art

The present invention specifically relates to an electrical switching device, in which an electrical through-switching is brought about by means of a conduction path being established in a switching element or in which an electrical switching-off is brought about by means of the conduction path being removed in the switching element. In this case, the switching element has a first electrode unit, a second electrode unit and an electrolyte layer arranged between and contact-connected to the first and second electrode units, the conduction path being formed between the first electrode unit and the second electrode unit via the electrolyte layer by means of conduction elements that have diffused from the first electrode unit into the electrolyte layer.

So-called CB cells (conductive bridging), which are also referred to as solid electrolyte memory cells, are suitable inter alia for the construction of memory cells. Memory cells of this type usually comprise an anode, a cathode and an ion conductor arranged between the anode and the cathode. In this case, the memory cell is formed as a resistively switching element whose total conductivity can be assigned to a memory state. For detecting the state of the cell, that is to say for detecting a logic state (logic “1” or logic “0”), the current at a predetermined applied read voltage U_{read} is evaluated.

The function of such a CB cell is explained below. Metallic ions are diffused from the anode material through the ion conductor, which generally exhibits poor electrical conductivity, by application of bipolar voltage pulses. The usually metallic ions are identical with the anode material in the simplest case. The conducting state of the cell is usually defined as the “on” state, while the nonconducting state of the cell is defined as the “off” state. Producing the conducting state is referred to as a write operation, while cancelling the conducting state, that is to say bringing about the nonconducting state, is defined as an erase operation.

During the write operation, owing to application of a positive write voltage U_{write}>U_{read}, a metallic anode material is oxidized and dissolves into the solid ion conductor. Such ion diffusion can be controlled by a time duration, an amplitude and a polarity of the impressed electrical voltage applied to the cell, or of the impressed electric current. After a sufficient number of metal ions have diffused from the anode into the solid electrolyte material, a low-resistance metallic bridge can form between the anode and the cathode in such a way that the electrical resistance of the memory cell decreases considerably.

An erase operation is brought about by applying an erase voltage Uₑᵣₐₛₑ, which has an opposite polarity compared with the read voltage U_{read}. In this case, the metallic bridge formed during the write operation is interrupted by an ion diffusion from the ion conductor back to the anode and a subsequent reduction of the metal ions at the anode, as a result of which the resistance of the cell increases considerably.

An essential disadvantage of conventional CB cells consists in the fact that, in particular during an erase operation, high voltages lead to high current densities and thus to the possibility of damage to the cell. On the other hand, it is inexpedient to use low erase voltages since slow diffusion of the ions into the anode leads to a disadvantageous reduction of the switching speed.

Conventional CB cells are based on programming (writing to) and erasing the memory cell exclusively by means of electrical voltage pulses in the forward and reverse direction, respectively. For writing, use is usually made of voltage pulses lying above the threshold of an electrolyte oxidation of the respective metal material or above the threshold for generating a metal ion, for example greater than 0.23 V for a CB cell formed form a selenium-containing solid electrolyte with silver ions.

On the other hand, for erasure, use is made of voltage pulses which are high enough to drive these metal cations again from their positions in the solid electrolyte from the metal-containing bridge cooperatively back in the direction of the (original) anode. In order to design this cooperative ion migration process in such a way that it has a high switching speed, it is necessary, on the one hand, to apply relatively high pulse amplitudes, while on the other hand the field strengths must not lead to excessive current densities in the cell, in order to avoid damage to the cell. It should be pointed out that in order to achieve high electric fields and thus high ion migration velocities, high pulse amplitudes are always required on account of the following equation:
v=μ E, and
U/d=E
where μ=ion mobility,
U=voltage,
d=layer thickness,
v=ion migration velocity, and
E=electric field strength.

A further essential disadvantage of the conventional method for programming or erasing a CB cell consists in the fact that the repeated application of high field strengths leads to degradation of the solid electrolyte material. Consequently, the CB cell inexpediently becomes non-functional after a number of switching operations.

Furthermore, one disadvantage of conventional CB cells consists in the fact that only asymmetrical operation of the CB cell is possible as a result of long erase pulses. It is furthermore disadvantageous that, in order to realize a sufficiently high data rate during an erase operation, the memory cell array has to be operated massively in parallel.

### SUMMARY OF THE INVENTION

It is an object of the present invention to design an electrical switching device based on CB cells in such a way that high current densities are avoided when writing to or erasing the CB cell, at the same time high switching speeds being achieved and damage to the CB cell being avoided.

The object is achieved in accordance with the invention by means of a switching device, in which an electrical through-switching is brought about by means of a conduction path being established in a switching element, the switching element comprising,

a) a first electrode unit;

b) a second electrode unit; and

c) an electrolyte layer arranged between and contact-connected to the first and second electrode units, the conduction path being formed between the first electrode unit and the second electrode unit via the electrolyte layer by means of conduction elements that have diffused from the first electrode unit into the electrolyte layer, and a heating device for heating the switching element furthermore being provided.

The object is also achieved in accordance with the invention by means of a switching method in which an electrical switching operation is brought about by a conduction path being established or removed in a switching element, the method essentially having the following steps:

a) connection of a first electrode unit;

b) connection of a second electrode unit;

c) provision of an electrolyte layer between the first and second electrode units and contact-connection thereof to the first and second electrode units; and

d) production of the conduction path between the first electrode unit and the second electrode unit via the electrolyte layer by means of a diffusion of conduction elements from the first electrode unit into the electrolyte layer, the switching element being heated during the switching operation by means of a heating device.

One essential concept of the invention consists in providing heating of a CB cell when writing to or erasing the CB cell, in such a way that thermally assisted writing or erasure is made possible. Such a CB cell is referred to hereinafter as a TACB cell (thermally assisted conductive bridging). In this case, the heating goes beyond Joule heating of the cell by the current flowing through the cell during writing and/or erasure. In this way, the present invention affords the advantage of avoiding erasure and/or writing with high pulse amplitudes, at the same time a high switching speed being achieved. Erasure is advantageously accelerated by a thermally induced diffusion process since the ion mobility increases as the temperature of the TACB cell increases. Consequently, the speed of the erase operation is advantageously increased on account of the temperature-dependent ion mobility.

The switching element may be formed as a memory cell.

The first electrode unit may contain a donor material, and the second electrode unit may be formed from a chemically inert material. The second electrode unit preferably serves as the cathode of the switching element, while the first electrode unit is designed as the anode of the switching element.

The electrolyte layer may be formed from a solid electrolyte material. Preferably, the solid electrolyte material comprises one or a plurality of the materials from the group consisting of germanium-selenium (GeₓSe₁₋ₓ), germanium sulphide (GeₓS₁₋ₓ), tungsten oxide (WOₓ), copper sulphide (Cu—S), copper-selenium (Cu—Se), similar chalcogenide-containing compounds or binary IV-VI compounds. Furthermore, terniary chalcogenide compounds, for example with nitrogen, such as GeSeN or GeSN, for instance, can be used.

The conduction elements that are deposited from the first electrode unit into the electrolyte layer may be metal ions.

The heating device for heating the switching element may be designed as a resistive heating element. It is furthermore possible to provide the heating device for heating the switching element has an integral component part of the switching element. The heating element is preferably designed in such a way as to heat the switching element to temperatures in the range of between 50° C. and 350° C.

The heating device may drive a current for heating the switching element through the arrangement formed from the first electrode unit, the electrolyte layer and the second electrode unit.

Furthermore, it is advantageously possible for the switching element to be heated by the heating device by means of current pulses. In this way, the electrical switching device of the present invention makes it possible to carry out switching operations at low current densities and high switching speeds.

### DESCRIPTION OF THE DRAWINGS

FIG. 1(a) is a schematic illustration of a TACB switching element.

FIG. 1(b) shows the schematic construction of the TACB switching element.

FIG. 2(a) shows the TACB switching element of FIG. 1(b), conduction elements having diffused into the solid electrolyte material, in an “off” state;

FIG. 2(b) is the cell of FIG. 1(b), conduction elements having diffused into the solid electrolyte material, in an “on” state of the TACB cell;

FIG. 3 is a schematic illustration of the TACB switching element with an assigned heating device.

FIG. 4(a) is the arrangement of the switching element or the TACB cell with heating device in a memory cell array, a bit line being used as heating line.

FIG. 4(b) are switching elements in a memory cell array with an assigned heating device, a contact-connecting line being used as connection line device.

FIG. 5(a) are TACB cells arranged in a memory cell array, assigned heating devices being connected via an erasure line.

FIG. 5(b) is the arrangement of FIG. 5(a) with a modified connection of the TACB cells to bit lines and word lines of the memory cell array.

FIG. 6 is a heating device-switching element pair in which the switching element is connected between a bit line and a word line and the heating element is connected to an erasure line.

FIG. 7 is an arrangement of heating device-switching element pairs in accordance with FIG. 6 in a memory cell array.

FIG. 8 is a heating device-switching element pair, the switching element being connected between a bit line and a word line, while the heating element is connected to an erasure line arranged parallel to the word line.

FIG. 9 is a memory cell array comprising heating device-switching element pairs in accordance with FIG. 8.

### DESCRIPTION OF THE PREFERRED EMBODIMENTS

In the figures, identical reference symbols designate identical or functionally identical components or steps.

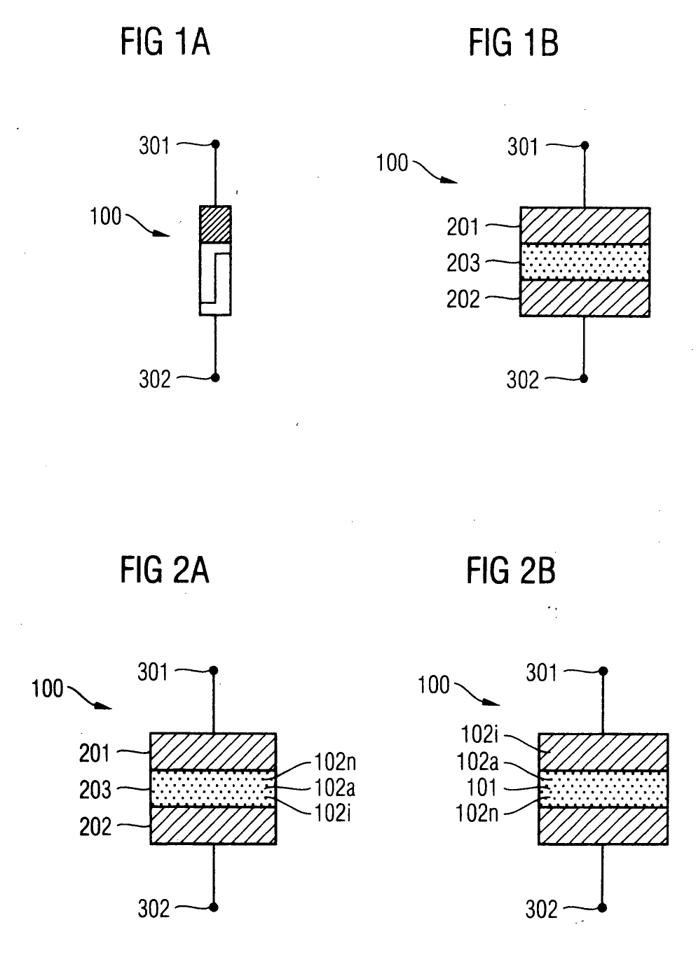

A TACB (thermally assisted conductive bridging) cell according to the invention is illustrated in FIGS. 1(a) and 1(b). In this case, such a TACB cell, which is designated hereinafter by the reference symbol 600, essentially has two terminal units, that is to say a first terminal unit 301 and a second terminal unit 302 for the switching element 100. While FIG. 1(a) shows a schematic circuit symbol of such a switching element 100, FIG. 1(b) schematically illustrates the construction of the switching element 100. The switching element 100 essentially comprises a first electrode unit 201 and a second electrode unit 202, the first electrode unit 201 being connected to the first switching terminal unit 301, while the second electrode unit 202 is connected to the second switching terminal unit 302.

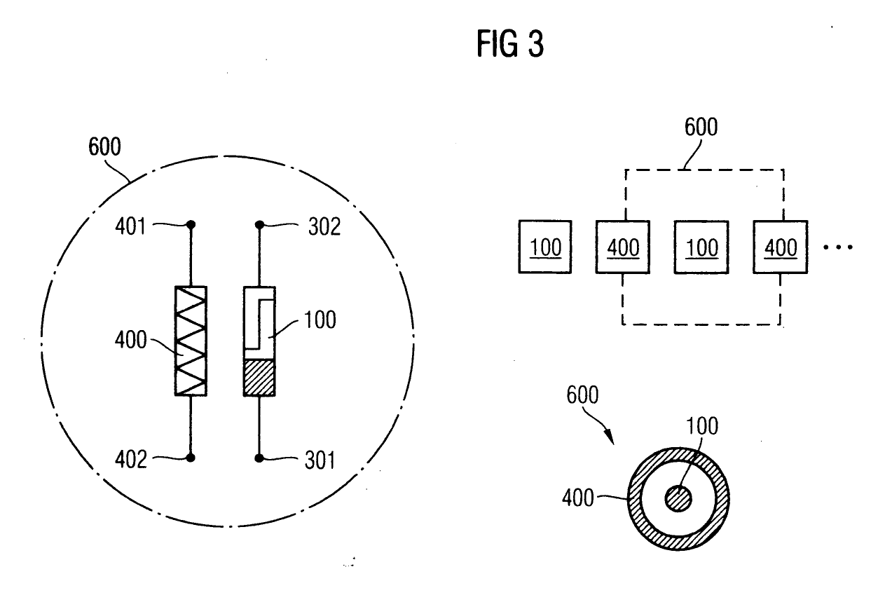

As will be explained below with reference to FIG. 3, the electrical switching device according to the invention furthermore has a heating device 400 besides the switching element 100, said heating device being arranged on or in the vicinity of the switching element 100, thereby forming a TACB cell 600.

In this case, the basic principle consists in the fact that the electrical switching device, in which an electrical through-switching is brought about by means of a conduction path being established in the switching element 100, has the heating device 400 for heating the switching element 100. More precisely, the switching element 100 comprises the first electrode unit 201, the second electrode unit 202 and an electrolyte layer 203 arranged between and contact-connected to the first and second electrode units 201, 202, the conduction path being formed between the first electrode unit 201 and the second electrode unit 202 via the electrolyte layer 203 by means of conduction elements that have diffused from the first electrode unit 201 into the electrolyte layer 203, the heating device 400 heating the switching element 100 during the switching operation. The TACB cell 600 is formed by the combination of the heating device 400 with the switching element 100. In this case, the heating device 400 may have separate electrical contacts and may also be embodied in a manner integrated into the switching element 100 by means of a high-resistance layer.

FIG. 2(a) shows that conduction elements 102a, 102b, . . . , 102i, . . . , 102n have diffused into the electrolyte layer 203 from the first electrode unit 201. It should be pointed out that the second electrode unit 202 is formed as a neutral or inert electrode. The first electrode unit 201 thus contains a donor material which ensures that the conduction elements 102a-102n diffuse into the electrolyte layer 203. FIG. 2(a) shows an “off” state of the switching element or the TACB cell, which may be designed as a memory cell. The “off” state is characterized in that although conduction elements 102a-102n are situated in the electrolyte layer 203, they do not form a conduction path between the first electrode unit 201 and the second electrode unit 202. In this way, an electrical insulation between the first electrode unit 201 and the second electrode unit 202 is ensured, while there is a high electrical resistance between the two electrode units 201, 202.

FIG. 2(b), by contrast, shows an “on” state of the switching element 100, which is characterized in that an electrical conduction path 101 is formed between the first electrode unit 201 and the second electrode unit 202. As shown in FIG. 2(b), a conductive bridge (that is to say a bridging in the conductive bridging switching element) is formed at at least one location in such a way that a number of conduction elements 102a-102n make contact in such a way that the electrical resistance between the first electrode unit 201 and the second electrode unit 202 is reduced. Furthermore, it is possible to provide such a small distance that a quantum mechanical tunnelling current is formed, for example a distance of less than 2 nanometers (nm). A formation of a conduction path 101 as shown in FIG. 2(b) is also referred to as writing to or “programming” the switching element.

FIG. 3 finally shows the switching element 100 having the first and second switching terminal units 301 and 302, respectively, the switching element 100 being assigned a heating device 400, which can be connected to an electrical current path via a first heating terminal unit 401 and a second heating terminal unit 402. The arrangement shown in FIG. 3 is referred to below as a heating device-switching element pair, that is to say as a TACB cell 600.

The heating device 400 essentially generates Joule heat which can be utilized for putting the switching element 100 from an “on” state, that is to say a state in which a metallic/metal-like bridge is formed, into an “off” state. The basic principle consists in the fact that the applied Joule heat, owing to the current density along the abovementioned metallic or metal-like track, heats the cell to be erased and triggers the resultant increased diffusive movement of the metallic atoms of the bridge within a very short time. This effect is used in the case of the TACB cell according to the invention or in the case of the switching element according to the invention in such a way that, by virtue of a suitably high temperature being provided by the heating device 400, the diffusion operation leads to an “off” state of the switching element 100 within a few nanoseconds (ns).

It is furthermore possible for the electrical erasure only to be thermally assisted. In this case, at the same time as the heating operation, an electric field is applied in such a way that conduction elements, preferably formed as metal atoms, diffuse back into the first electrode unit 201. In this case, the advantage over conventional switching elements based on CB cells is that such erasure can be carried out with a low field strength simultaneously with the heating operation. It is furthermore advantageous that the erasure duration is reduced.

It should be pointed out that thermally assisted writing to or “programming” of the switching element or the TACB cell can be carried out in the same way.

This involves making use, during writing and erasure, of the physical fact that the mobility of the metal ions exhibits a considerable temperature dependence, that is to say μᵢₒₙ=μᵢₒₙ (T) where μ(T₁)<<μ(T₂), if Tᵢ<<T₂.

In principle, there are three possible options for heating of the switching element 100 by the heating device 400 according to the invention:

a) the heating current flows directly through the switching element 100;

b) the heating current does not flow through the switching element 100 but only through the heating device 400, which is arranged in the vicinity of the switching element 100 (heating device-switching element pair); and

c) the heating current flows partly through the switching element 100 and partly through the heating device 400.

The embodiments specified above differ with regard to an embodiment and contact-connection of the heating devices 400. In case a) mentioned above, thermal heating is achieved by virtue of the fact that the heating current is sent directly through the cell or through a series-connected resistance heating element (e.g. in the form of a resistive electrode), the heating element being directly integrated into the TACB cell. Such an arrangement can be realized by a suitable selection of heating resistors in parallel or in series.

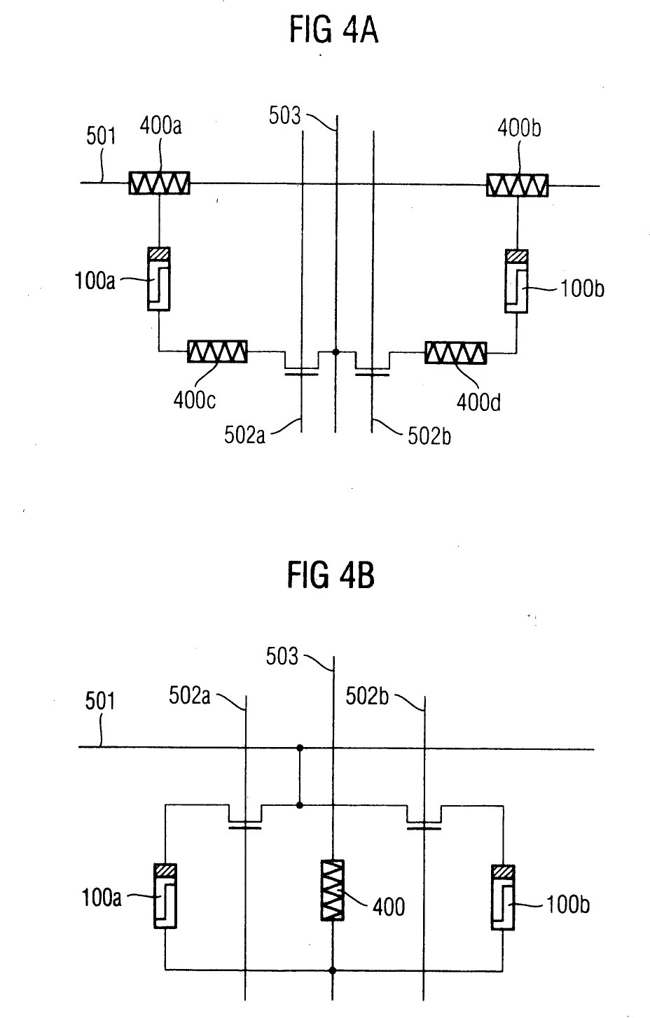

Embodiment d) can be realized by using an additional heating line or an existing line, such as a wiring line for example, as a heating line, as will be explained below in different arrangements with reference to FIGS. 4-9.

Embodiment c) is correspondingly a combination of embodiments a) and b).

Preferred embodiments of the present invention will be described below with reference to FIGS. 4-9.

The embodiments described below are aimed at forming a memory cell array with an array comprising a multiplicity of switching elements according to the invention or a multiplicity of heating device-switching element pairs or TACB cells 600.

FIG. 4(a) shows an arrangement which uses two heating device-switching element pairs (designated in each case by the letters a, b, c, . . . , i, . . . , n appended to the respective reference symbols).

In the exemplary embodiment shown in FIG. 4(a), the corresponding heating devices 400a and 400b are then connected to a bit line 501, through which a sufficiently high current must be introduced for heating the respective switching elements 100a and 100b. In this case, the switching elements 100a, 100b, which are used as memory cells, are each connected between the bit line 501 and a corresponding word line 502a and 502b, respectively. A contact-connecting line 503 is furthermore shown, which is not acted on by the heating device-switching element pair according to the invention in the exemplary embodiment shown in FIG. 4(a).

As is furthermore illustrated in FIG. 4(a), heating elements 400c, 400d may be provided in addition to or instead of the heating elements 400a, 400b. In this case, the additional heating elements 400c, 400d are connected in series with the associated switching elements 100a, 100b.

FIG. 4(b) shows a different arrangement, in which the contact-connecting line 503 is used for the connection of the heating device 400. In the arrangement shown in FIG. 4(b), the heating device 400 is arranged between the two switching elements 100a, 100b and heats both switching elements 100a, 100b of this type. The switching elements themselves are arranged between the word line 502a and 502b, respectively, and the bit line 501.

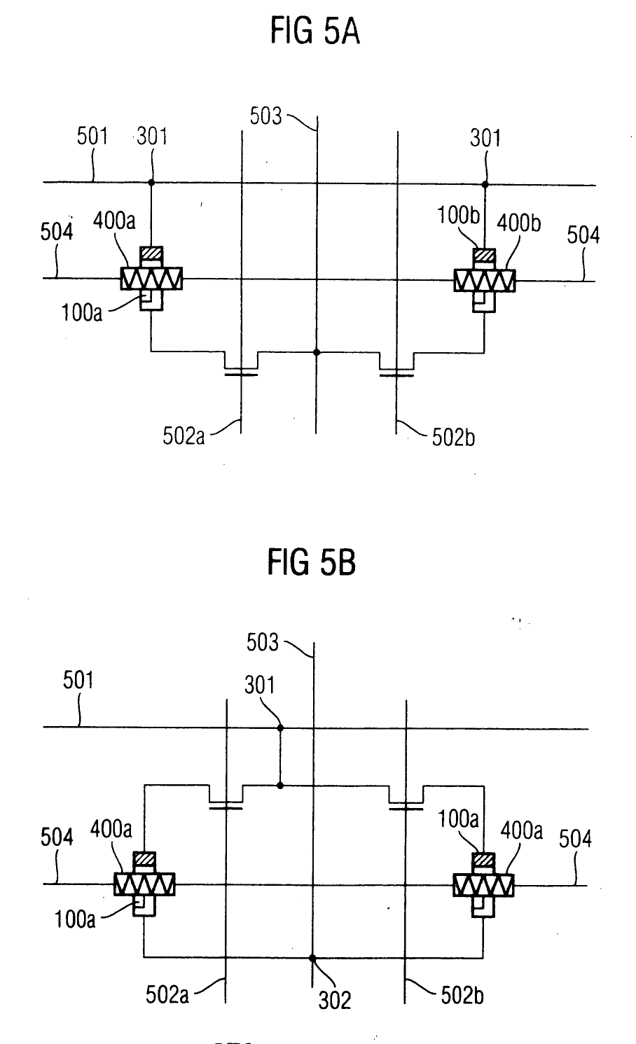

FIG. 5(a) shows a further exemplary embodiment, in which the current for the heating device 400a and 400b is fed via the erasure line 504. In this case, the corresponding switching element 100a, 100b is driven via the bit line 501 or the word lines 502a, 502b, while the contact-making line 503 is not acted on by the heating device 400.

FIG. 5(b) shows a variant of the arrangement shown in FIG. 5(a). As shown in FIG. 5(b), here the erasure line is once again designed as a heating line, in such a way that the erase current (or the write current) is fed for heating to the heating device 400 via the erasure line 504.

The respective switching elements 100a, 100b are connected between the bit line 501 and the contact-connecting line 503 with the respective switching terminal units 301 and the respective second switching terminal units 302.

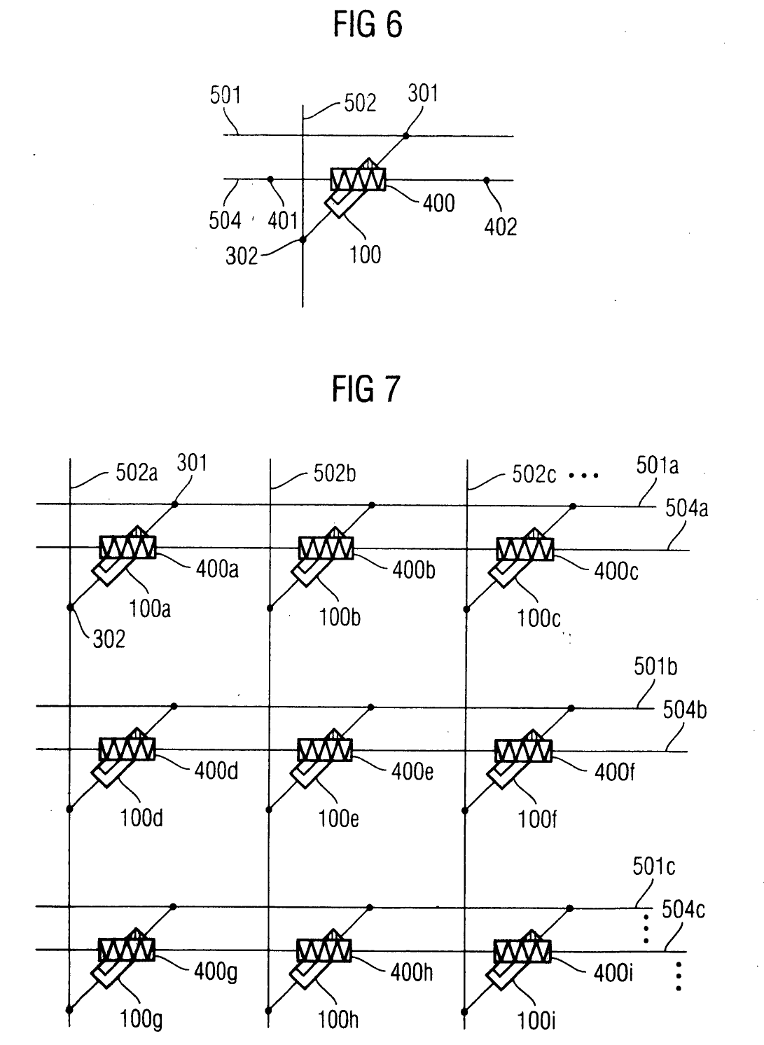

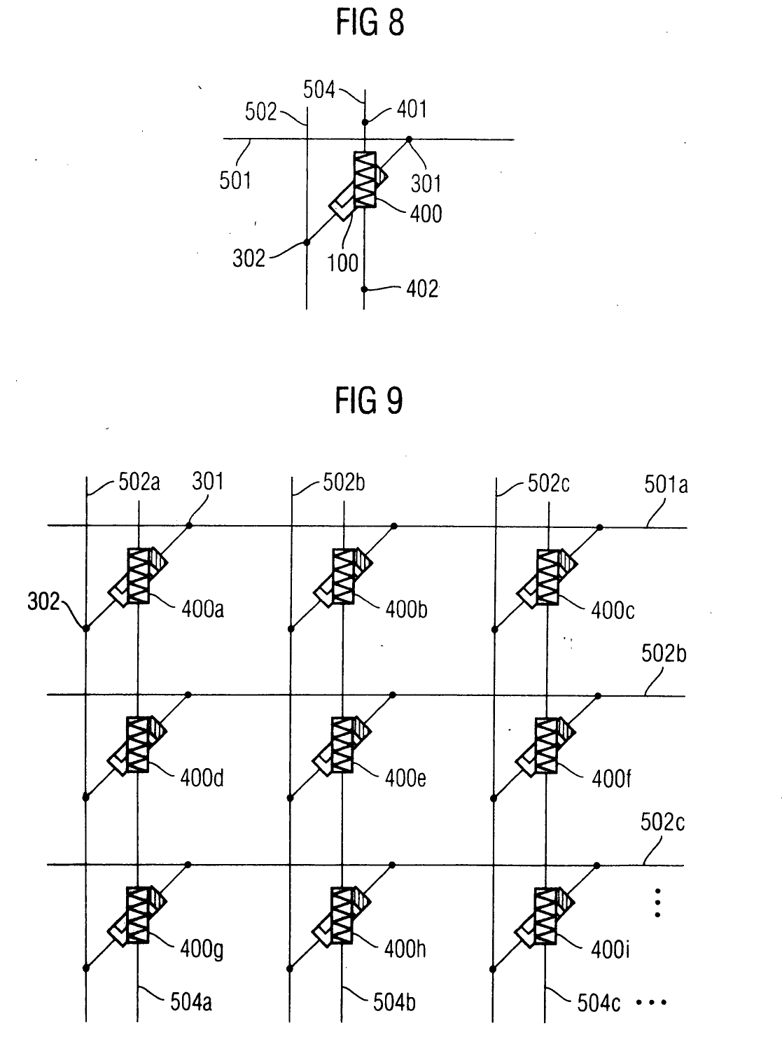

FIGS. 6-9 show the design of a memory cell array formed from heating device-switching element pairs or TACB cells 600 in two different embodiments. While FIGS. 6 and 7 show an arrangement in which the erasure lines 504a-504n are oriented parallel to the bit lines 501a-501n in the memory cell array, the erasure lines 504a-504n are arranged perpendicular to the bit lines 501a-501n in the arrangement shown in FIGS. 8 and 9.

FIG. 6 shows a heating device-switching element pair comprising the heating device 400 and the switching element 100, the switching element 100 being connected to the bit line 501 via the first switching terminal unit 301, while the switching element 100 is connected to the word line 502 via the second switching terminal unit 302. As shown above with reference to FIG. 3, the heating device 400 has a first heating terminal unit 401 and a second heating terminal unit 402, which are connected to the erasure line 504 in the arrangement shown in FIG. 6.

FIG. 7 shows a memory cell array comprising heating device-switching element pairs or TACB cells 600 in accordance with FIG. 6.

The arrangements shown in FIGS. 8 and 9 correspond to those of FIGS. 6 and 7 to the effect that an arrangement of heating device-switching element pairs or TACB cells 600 is designed in the form of a memory cell array. As shown in FIG. 8, the switching element 100 is connected to the bit line 501 via the first switching terminal unit 301, while the switching element 100 is connected to the word line 502 via the second switching terminal unit 302. The word line 502 is oriented parallel to the erasure line 504, in which the heating device 400 of the heating device-switching element pair or of the TACB cell 600 is situated. The heating device 400 is connected to the erasure line 504 via the first heating terminal unit 401 and the second heating terminal unit 402.

FIG. 9 finally shows a memory cell array comprising heating device-switching element pairs or TACB cells 600 in accordance with FIG. 8.

While the erasure lines 504a-504n in the arrangement shown in FIG. 7 may be arranged above or below the memory cell array parallel to the bit lines 501a-501n, the erasure lines 504a-504n are arranged parallel to the respective word lines 502a-502n in the example shown in FIG. 9. The arrangement shown in FIG. 7 has the advantage that the resistive heating elements can be addressed at each switching element by means of the erasure lines 504a-504n, it being possible to avoid the critical erasure in the “crosspoint arrays” by means of voltage pulses having high amplitudes. One disadvantage of this arrangement is that all the cells assigned to a bit line 501a-501n are erased in this way (also referred to as a “block erase”).

By contrast, in the arrangement shown in FIG. 9, all the cells which are assigned to a corresponding word line 502a, 502n are erased in an erase operation.

The solid electrolyte material from which the electrolyte layer 203 is formed (see, inter alia, FIG. 2(a) and (b)) is preferably formed from one or a plurality of materials from the group consisting of germanium-selenium (GeₓS₁₋ₓ), germanium sulphide (GeₓS₁₋ₓ), tungsten oxide (WOₓ), copper sulphide (Cu—S), copper-selenium (Cu—Se) or similar, for example binary or ternary chalcogenide-containing compounds.

The conduction elements deposited into the electrolyte layer 203 from the first electrode unit 201 are preferably clusters of metal ions, metal compounds or metal-containing deposits having typical diameters in a range of 5-10 nm.

There is the possibility of the metal in a TACB cell 600 agglomerating cumulatively in the solid electrolyte after many heating pulses. Therefore, it may be necessary to reset the TACB cells 600 into an original state by means of suitable additional electrical erase pulses. This can be taken into account by the circuit design, however, in such a way that reset pulses that remain hidden to the user of the circuit element are introduced in such a way that these pulses are carried out after the actual operating cycles, e.g. when the circuit arrangement is switched on or when the circuit arrangement is switched off. However, stringent speed requirements are not made of such erase or write pulses.

The thermally induced diffusion process is made possible by virtue of the temperature dependence of the ion mobility μ=μ(T). An activation energy for the thermal erasure, that is to say for the transition of an “on” resistance from approximately 10-100 kΩ to a few GΩ or higher, is approximately 0.25 eV, which leads to an erasure time of a few microseconds to nanoseconds if temperatures in a range of 190° C. to 200° C. are generated by the heating device 400. Such temperatures can be obtained in a simple manner through obtainable current intensities in resistance materials based on the Joule effect and do not damage the memory cell array formed from the heating device-switching element pairs or TACB cells 600.

The heating device 400 for heating the switching element 100 may be designed as an integral component part of the switching element 100. The “TACB cell” 600 is formed by the combination of the heating device 400 with the switching element 100.

In one preferred embodiment, the heating device 400 for heating the switching element 100 is formed as a resistive heating element. The heating device 400 preferably drives a current for heating the switching element 100 through the arrangement formed from the electrode unit 201, the electrolyte layer 203 and the second electrode unit 202. In this case, it is possible for the heating device 400 to heat the switching element 100 by means of current pulses in a pulsed mode of operation. Bipolar pulsing can be used in this case, which does not influence the memory state of a TACB cell 600. For this purpose, it is possible to use pulses having a time duration in the nanoseconds range and having a pulse voltage below the switching threshold (Vₜ of approximately 0.25 V). Typical temperatures to which the heating device 400 heats the corresponding assigned switching element 100 lie in a range of between 50° C. and 350° C.

Preferred heating materials comprise metals and metal nitrides, in particular conductive metal nitrides of CMOS materials such as WNₓ, TiNₓ, TaNₓ, TiSiₓN_{y}, TaSiₓNy, WSiₓN_{y}. Furthermore, metal silicides such as TiSiₓ, WSiₓ, CoSiₓ, NiSi_{y}, TaSiₓ or doped polycrystalline silicon materials such as n-poly-Si, p-poly-Si can advantageously be used.

Although modifications and changes may be suggested by those skilled in the art, it is the intention of the inventors to embody within the patent warranted heron all changes and modifications as reasonably and properly come within the scope of their contribution to the art.

We claim as our invention:

1. An electrical switching device, comprising:
a switching element; and
a heating device for heating said switching element;
said switching element comprising a first electrode, a second electrode, and an electrolyte layer arranged between and contact-connected to said first and second electrode; said switching element being configured to establish a conducting path between said first and second electrodes via said electrolyte layer by conduction elements having diffused from said first electrode into said electrolyte layer.

2. The device of claim 1, wherein said switching element is formed as a memory cell.

3. The device of claim 1, wherein said first electrode comprises a donor material.

4. The device of claim 1, wherein said second electrode is formed from a chemically inert material which has no or only little solubility in the material of said electrolyte layer.

5. The device of claim 1, wherein said electrolyte layer is formed from a solid electrolyte material.

6. The device of claim 5, wherein said solid electrolyte material comprises at least one of a material taken from a group consisting of germanium-selenium (GeₓSe₁₋ₓ), germanium sulphide (GeₓS₁₋ₓ), tungsten oxide (WOₓ), copper sulphide (Cu—S), copper-selenium (Cu—Se), or binary or ternary chalcogenide-containing compounds.

7. The device of claim 1, wherein said conduction elements that are deposited from said first electrode into said electrolyte layer are metal ions.

8. The device of claim 1, wherein said heating device for heating said switching element is a resistive heating element.

9. The device of claim 1, wherein said heating device for heating said switching element is an integral component part of said switching element.

10. A memory cell array, comprising an array of switching devices of claim 1.

11. A switching method, in which an electrical switching operation is brought about by a conduction path being established or removed in a switching element which is comprises of a first electrode, a second electrode and an electrolyte layer between said first and second electrodes; said method having the steps of:
defusing conduction elements from said first electrode into said electrolyte layer in order to generate said conduction path between said first and second electrodes via said electrolyte layer; and
heating said switching element during said switching operation by means of a heating device.

12. The method of claim 11, comprising depositing metal ions as conduction elements from said first electrode into said electrolyte layer.

13. The method of claim 11, comprising heating said switching element to temperatures in the range of between 50° C. and 350° C. by said heating element during said electrical switching operation.

14. The method of claim 11, wherein said heating device drives a current for heating said switching element through said switching element.

15. The method of claim 11, wherein said heating device heats said switching element by means of current pulses.

16. The method of claim 15, wherein said switching element has a memory content which remains unchanged during said heating.
